(19) United States
(12) Patent Application Publication
(10) Pub. No.: US 2002/0097847 A1
(43) Pub. Date: Jul. 25, 2002

(54) Communicational internet safety system and the method of the same

(76) Inventor: Fujino Kozo, Miura-Gun (JP)

Correspondence Address: Keith Kline, PRO-TECHTOR INTERNATIONAL SERVICES, 20775 Norada Court, Saratoga, CA, 95070-3018, US

(21) Appl. No.: 10/046,872

(22) Filed: Jan. 14, 2002

(30) Foreign Application Priority Data
Jan. 19, 2001 (JP) 2001-047388

(51) Int. Cl. H04M 1/64

(52) U.S. Cl. 379/88.17

(57) ABSTRACT

A communicational Internet safety system and the method of the same. The system comprises a receiving server for receiving or sending information to a terminal in a predetermined time for executing necessary determination; a plurality of different communicational Internet for being connected to a receiving server and to a sending terminal; and a sending terminal connected to the receiving server for sending fence to the receiving server through a plurality of different communicational networks. The sending terminal is capable of switching different networks automatically in a predetermined time. By above arrangement, the receiving server determines whether a transaction is performed based on information of the same receiving terminal of the plurality of different communicational networks. Thereby, an electronic business can be executed in a safety environment.

### FIELD OF THE INVENTION

The present invention relates to a communicational Internet safety system and the method of the same, and particularly to a system and method, wherein the receiving server determines whether a transaction is performed based on information of the same sending terminal connected to a plurality of different communicational network.

### BACKGROUND OF THE INVENTION

In general, the communication is encrypted and is verified by a verification organization for a communicational Internet safety system. However, the current verification technology and encryption technology can not assure that a computer system does not be intruded by intruder. Therefore, the novel system and method is necessary for improving the prior art defects.

### SUMMARY OF THE INVENTION

Accordingly, the primary object of the present invention is to provide a communicational Internet safety system and the method of the same, wherein the user may publish information, pay fees and charging in a safety environment.

Another object of the present invention is to provide a communicational Internet safety system and the method of the same, wherein the user may publish information, pay fees and charging about an electronic business, thereby, the user performs a business through a plurality of different networks in a safety environment.

Another object of the present invention is to provide a communicational Internet safety system and the method of the same, wherein the connection of a plurality of networks to a personal computer or a mobile phone is switched by a build-in modem in the computer or mobile phone.

Therefore, the user's terminal may be connected to different communicational networks, such as telephone wires, ISDN network, wireless networks, Internet, etc. Once the user's terminal is connected to one of above networks. The receiving server will receive telephone number (sender's number) through the telephone wires, ISDN network, wireless networks, Internet, etc. Next, the user's terminal switches the telephone number, ISDN network, or wireless network to Internet. The communicational network using Internet sends the registered ID and passwords to the receiving server. The receiver server compares the registered telephone number, ID and password with those stored in a database. If they are matched to one another, then the information is published. Otherwise, if the same user does not send above data or not receive the information, then the information will not be published.

As described above, the telephone number of the receiving end is used as a determination. If the computer terminal or the mobile phone is not connected to the registered telephone number, then the transaction is not effective.

When a user pays fee in Internet; the payment information is verified through the communicational network of Internet. When the user's terminal is switched to the telephone wire, ISDN network, or wireless communicational network from Internet for sending telephone number (sender's number) to the receiving server. The receiving server identifies the telephone number. The receiving server compares the registered telephone number, ID, password with those in the database. If they are matched to one another, the expanse is assured, then the expanse is processed. If the same user does not send the information in a predetermined time or dose not receive the data, then it is not assured. Similarly, the computer terminal or mobile phone is not connected to the computer terminal, then the fee is not assured.

Above way is used for the computer terminal or mobile phone having a registered telephone number. In a predetermined time, the user's terminal sends information to receiver through a plurality of communicational network. If not, the transaction cannot be closed.

The various objects and advantages of the present invention will be more readily understood from the following detailed description when read in conjunction with the appended drawing.

### BRIEF DESCRIPTION OF THE DRAWINGS

FIG. 1 is a structural schematic view of the communicational Internet safety system of the present invention.

FIG. 2 is a systematic schematic view of the first embodiment of the communicational Internet safety system according to the present invention.

FIG. 2A is a flow diagram showing the first embodiment of the communicational Internet safety system of the present invention.

FIG. 3 is a systematic schematic view showing the second embodiment of the communicational Internet safety system of the present invention.

FIG. 3A is a flow schematic view of the second embodiment of the communicational Internet safety system of the present invention.

FIG. 4 is a systematic schematic view of the third embodiment of the communicational Internet safety system of the present invention.

FIG. 4A is a flow schematic view of the third embodiment of the communicational Internet safety system of the present invention.

### DETAILED DESCRIPTION OF THE PREFERRED EMBODIMENTS

Referring to figures, the present invention will be described in the following.

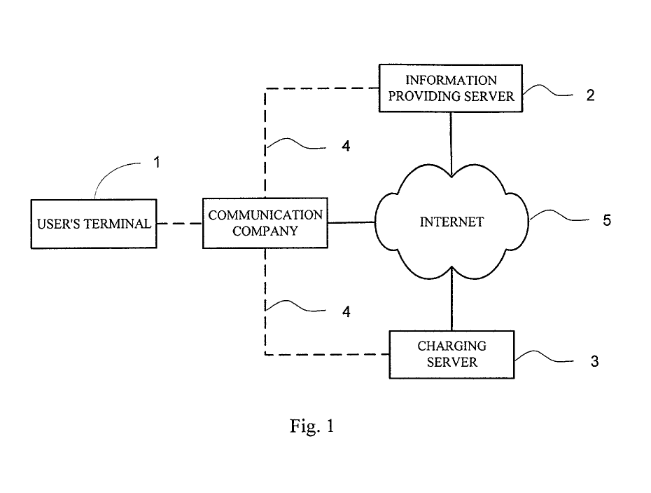

FIG. 1 shows the structure of the communicational Internet safety system structure. As shown in the figures, a user's terminal 1 for the payment of commercial purchase and public fee is illustrated in the drawings, information providing server 2 for providing expense information, a charging server 3 for collecting expenses are interconnected by Internet 5 and telephone wire 4 and other Networks, Besides, information providing server 2 and the charging server 3 are connected through Internet 5. When the user connected to a network, the wire for connecting to the network may be telephone wire, ISDN network or ADSL network. When the user's mobile phone is connected to a network, for the reason of conveniently describing, an embodiment that a user connects to a network through a computer is described herein.

A system schematic view about the first embodiment of the communicational Internet safety system of the present invention is illustrated. This is a schematic view for a communicational network of a service provider for providing information base on registered members that pay fees to the provider. At first, the user's terminal 1 is connected to the information providing server 2 through telephone wires or ISDN network (L11). Next, the telephone wire or ISDN network between the user's terminal 1 and the information providing server 2 is switched to Internet (L12). The information providing server 2 sends information to a charging server 3 (L13) of an expanse collect company. Finally, by using telephone wire or ISDN network, the user's terminal 1 informs the charging server 3 (L14) about the event of sending information to the information providing server 2 through Internet.

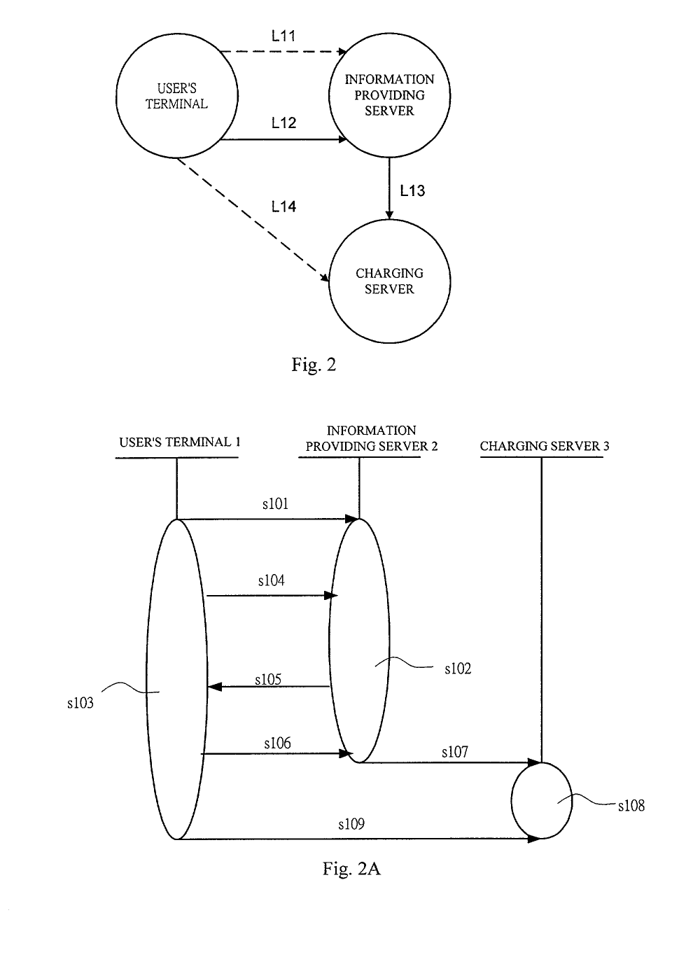

With reference to FIG. 2A, the flowing process of the user's terminal 1, information providing server 2 and charging server 3 is illustrated.

To request the information provider for publishing information, the user's terminal 1 is connected to a telephone wire or ISDN network, thereby, the user may identify the telephone number (sender's number) (s101). Then, the information providing server 2 determines whether the telephone number has been registered. If yes, the register file database indicates a timing token appended (s102). The user's terminal 1 switches the telephone wire or ISDN network to Internet by input IDs, passwords, and others (s103). The ID and password is transferred to the information providing server 2 (s104). The information providing server 2 identifies whether the registered telephone number has been indicated with a token by the ID and password. If yes, the information is published (s105). If no, the request is denied (s106).

After the user's terminal 1 has browsed the published information, it sends the data about fee payment to the information providing server 2 (s106). At the time that the information providing server 2 stores the information about sending fee payment data, the message and data of the registered person for fee charging is sent to the charging server 3 through the Internet (s107). The charging server 3 stores the payment data and the register's data from the information providing server 2. Then the telephone number of the registered person is indicated by a timing token (s108).

After the user's terminal 1 has completed the process of paying fees, the Internet is switched back to the telephone wire, ISDN network so that the user's terminal 1 is connected to the charging server 3 (s109). The charging server 3 identifies the telephone number from the user's terminal 1 (sender's number) and then stores it. The charging server 3 identifies the stored telephone number (sender's number) from the telephone wire, ISDN network and the telephone number registered in the register's data of the information providing server 2 for determining whether the two are matched and whether the former one is indicated by a token. If yes, then the data for paying expense from the information providing server 2 is sent to an expanse informing and processing department (s108). If not, the charging server 3 sends back the unmatched telephone number (sender's number) and the reason of rejection to the information providing server 2. The information providing server 2 sends the reason to the expanse payment terminal having registering a telephone number (not shown).

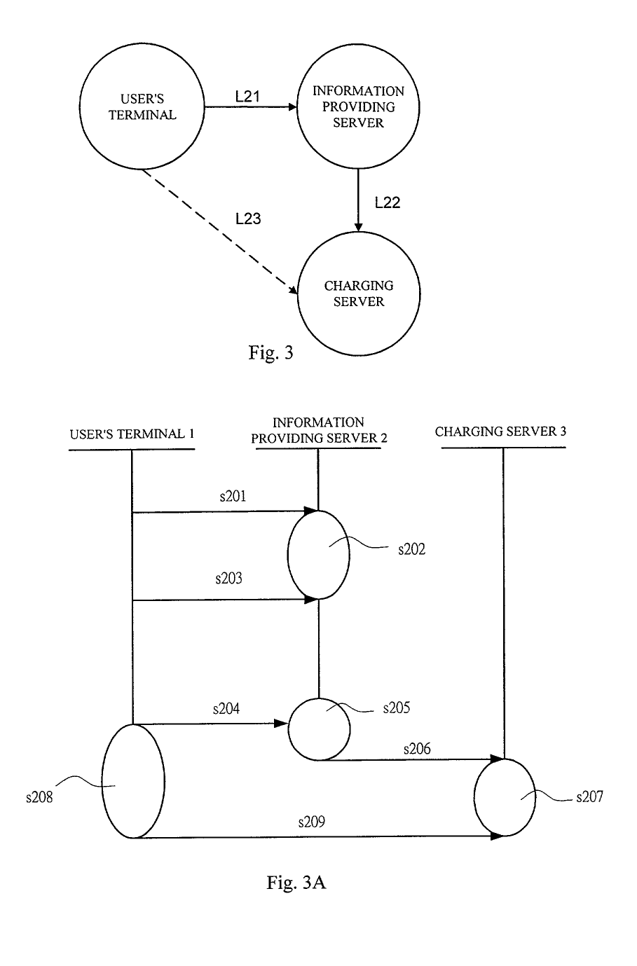

FIG. 3 is a systematic schematic view about the second embodiment of the communicational Internet safety system of the present invention, wherein a drawing showing communication network of information provider which publish information and executes electronic business is illustrated. The user's terminal 1 is connected to the information providing server 2 of an information provider. Thereby, the data can be reviewed and the data required by the user can be sent to the user (L21). The information providing server 2 transfers the information to the charging server 3 of an expanse charge company through Internet (L22). Finally, the user's terminal 1 informs the charging server 3 through the telephone wire or ISDN network about an event that the user ever sent data to the information providing server 2 (L23).

Referring to FIG. 3A, the data flow of the user's terminal 1, information providing server 2 and charging server 3 is illustrated.

The user's terminal 1 inputs registered ID, password for entering to the system to for request information publication (s201). The information providing server 2 determines whether the entered ID and password has been registered (s102) and the information is published (s203). After the user's terminal 1 assures that the information has be published, the data for paying fees is sent to the information providing server 2 (s204). The information providing server 2 stores the fee payment data from the user's terminal 1 (s205). At the same time for storage, it is sent to a charging server 3 (s206). The charging server 3 stores the fee payment data from the information providing server 2 (s207). After the fee payment data is sent, the user's terminal 1 is switched to the telephone wire network from Internet (s208) to inform the charging server 3 of the telephone number (sender's number), etc. The charging server 3 identifies the telephone number of the user's terminal 1 and the telephone number is compared with telephone number registered in the fee payment data stored in the step s207. It they are matched with one another, then the fee payment data is transferred to the fee informing and processing department (not shown). If they are unmatched, then the reason of rejection is sent back to the information providing server 2 (not shown).

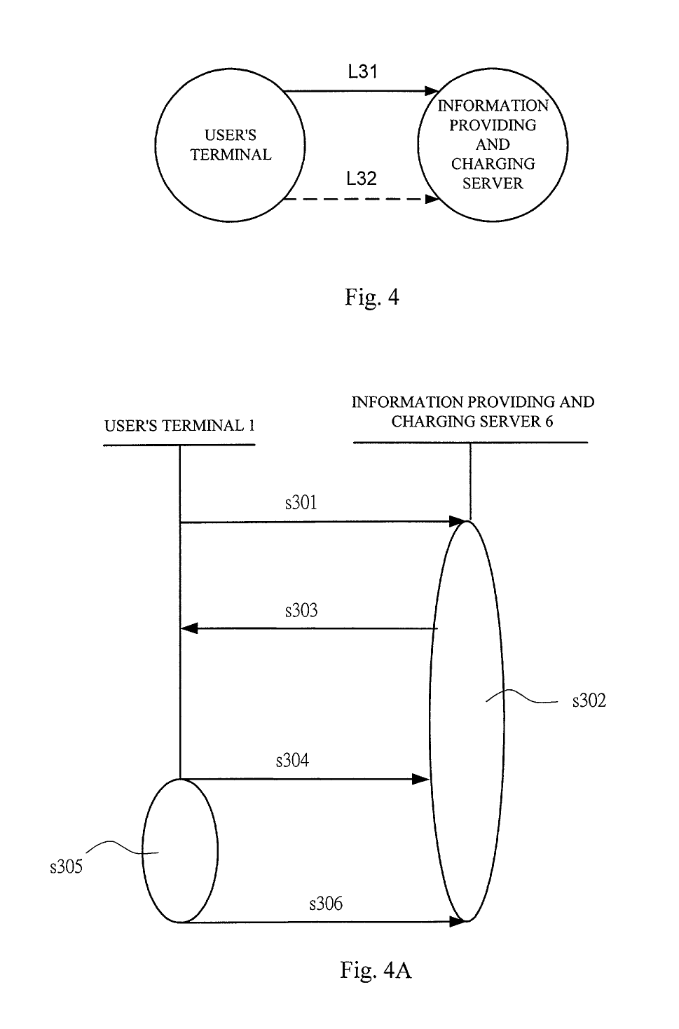

FIG. 4 shows a systematic schematic view of the third embodiment of the communicational Internet of the present invention. A schematic view of a communicational Internet as business company executes electronic business, and exhibits commercial products are illustrated. The user's terminal 1 is connected to the information providing and charging server 6 through Internet (L13) for browsing information and sending fee payment data. By sending fee payment data, the user's terminal 1 is switched to the telephone wire, ISDN network for informing that information has been charged and the fee charged has been completely.

Referring to FIG. 4A, the flow between the user's terminal 1, and the information providing and charging server 6 of a company engaging information providing and charge is illustrated.

The user's terminal 1 inputs the ID and password to the information providing and charging server 6 for entering into the system for publishing information (S301). The information providing and charging server 6 determines whether the entered ID and password has been registered (s302) and publishes data (s303). After the user's terminal 1 assures that the information has been published, the charge process is executed and data of the charge process is sent to the information providing and charging server 6 (s304). After the charge data is sent, the user's terminal is connected to a telephone network from Internet (s305) to instruct the information provider to inform the information providing and charging server 6 of the telephone number (sender's number) (s306). The information providing and charging server 6 identifies the telephone number from the user's terminal 1, and then the telephone number is compared with the telephone number in the fee payment data from s302. If the two are matched, the fee payment data is transferred to the fee informing and processing department (not shown). If they are not matched to one another, then reason of object is sent back to the user's terminal 1.

In the present invention, the registered telephone number of the user is used in connection. Even if the communicational Internet is intruded illegally. If the receiver's server can not identify the telephone number from the user's terminal. If in a predetermined time period, the same information cannot be received from a different communicational Internet. If the information transaction cannot be performed, then it is not useful. Besides, even the user does not admit that he ever used it. Since the receiving server of the user will record the message sender, the intrusion can be prevented.

Furthermore, although a validation from a validation office can be used to prevent information form being illegally used. However, the process is complicated. The present invention only need one registering process and process is simple and convenient for users.

What is claimed is:

1. A communicational Internet safety system comprising:
a receiving server for receiving or sending information to a terminal in a predetermined time for executing necessary determination;
a plurality of different communicational Internet for being connected to a receiving server and to a sending terminal; and
a sending terminal connected to the receiving server for sending information to the receiving server through a plurality of different communicational Internet, the sending terminal being capable of switching different networks automatically in a predetermined time;
wherein by above arrangement, the receiving server determines whether a transaction is performed based on information of the same receiving terminal of the plurality of different communicational network.

2. The communicational Internet safety system as claimed in claim 1, wherein the receiving server is actuated by a telephone number from a sending terminal through one of a telephone wire, ISDN network, ADSL network and wireless communicational networks and then identifies the sending terminal.

3. The communicational Internet safety method, wherein a receiving server receives information sent from or to a terminal for making determination.

4. The communicational Internet safety system as claimed in claim 3, wherein the terminal for sending information automatically switches between different networks in a predetermined time.

5. The communicational Internet safety system as claimed in claim 3, wherein the receiving server determines whether a transaction is performed based on information of the same receiving terminal of the plurality of different communicational networks.

6. The communicational Internet safety system as claimed in claim 3, wherein the receiving server is actuated by a telephone number from a sending terminal through one of a telephone wire, ISDN network, ADSL network and wireless communicational network and then identifies the sending terminal.
